(19) United States
(12) Patent Application Publication
(10) Pub. No.: US 2012/0322519 A1
(43) Pub. Date: Dec. 20, 2012

(54) AGRICULTURAL VEHICLE UTILIZING A HARD OBJECT DETECTION ASSEMBLY

(76) Inventors: James E. Straeter, Rochester, IN (US); Calvin G. Gray, Richmond, VA (US); George William Slade, Zonhoven (BE); Daniel Leonard Orban, Leuven (BE); Timothy H. Eyerman, El Paso, TX (US)

(21) Appl. No.: 13/160,594

(22) Filed: Jun. 15, 2011

(51) Int. Cl. A01D 75/18

(52) U.S. Cl. 460/2

(57) ABSTRACT

An agricultural vehicle having a frame and an inlet for intaking crop mat. A hard object assembly is attached to the frame and includes transmitting antennae for transmitting microwaves and a receiver system that receives the microwaves in order to detect hard objects within the crop mat.

### BACKGROUND OF THE INVENTION

This invention relates to agricultural vehicles. More specifically, this invention relates to a hard object detection assembly utilized on a agricultural vehicle.

Agricultural vehicles such as combines typically transverse through a field and pick up crop mat that include cellulosic crop materials and grain. Specifically, the cellousic materials or stover is picked up off the field into an intake of a machine such as a baler.

Problems result during the picking up of such crop stover or crop mat in that oftentimes hard objects such as rocks, pieces of concrete, metal or the like can be in a field and within the crop mat. As a result, the intake of the hard object causes damage to the interior systems of the machine harvesting the crop. Repairing such damage not only can be very expensive but additionally time consuming. Thus, a need in that art exists for a detection system that can determine when the crop matting contains such hard objects so that an operator can remove the hard object from the path of the agricultural vehicle preventing damage. Currently, mechanical rock detection systems consume power and damage grain and acoustical systems are compromised by rocks hidden in crop material that never touch the system's sounding board.

In other fields of endeavor such as mineral detection, pulse microwaves are used in order to determine where rocks exist as compared to valuable minerals. Typically, such an application of the microwaves is utilized as a heat detection system to determine where rocks exist. Still, these uses of microwaves are specific to the mineral detection fields and the use of detection systems for detecting rock in cellousic materials such as crop mat has not been attempted.

Thus, a principle object of the present invention is to provide a hard object detection system for an agricultural vehicle.

Yet another object of the present invention is to provide a cost effective system for detecting hard objects in association with an agricultural vehicle or stationary crop processing machine such as a grinder.

These and other objects, advantages, and features will become apparent from the specification and claims.

### BRIEF SUMMARY OF THE INVENTION

An agricultural vehicle having a frame with an inlet for intaking a crop mat. A hard object assembly is connected to the frame and includes a plurality of antennae for transmitting microwaves and a receiver system. The antennae transmit microwaves that are received by the receiver system to detect a hard object within the crop mat.

### BRIEF DESCRIPTION OF THE DRAWINGS

FIG. 1 is a side plan view of an agricultural vehicle with a hard object assembly;

FIG. 2 is a schematic diagram of a hard object assembly;

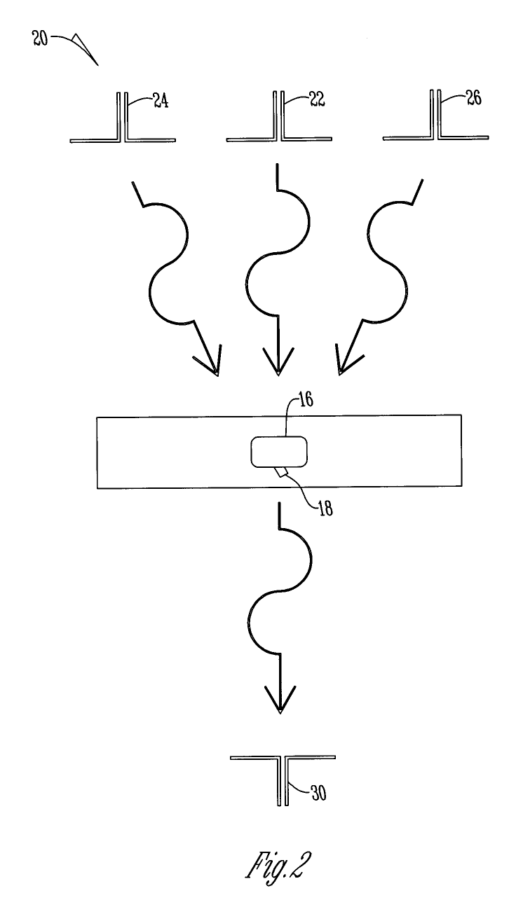

FIG. 3 is a schematic diagram of the hardware architecture of a receiver assembly of a hard object assembly;

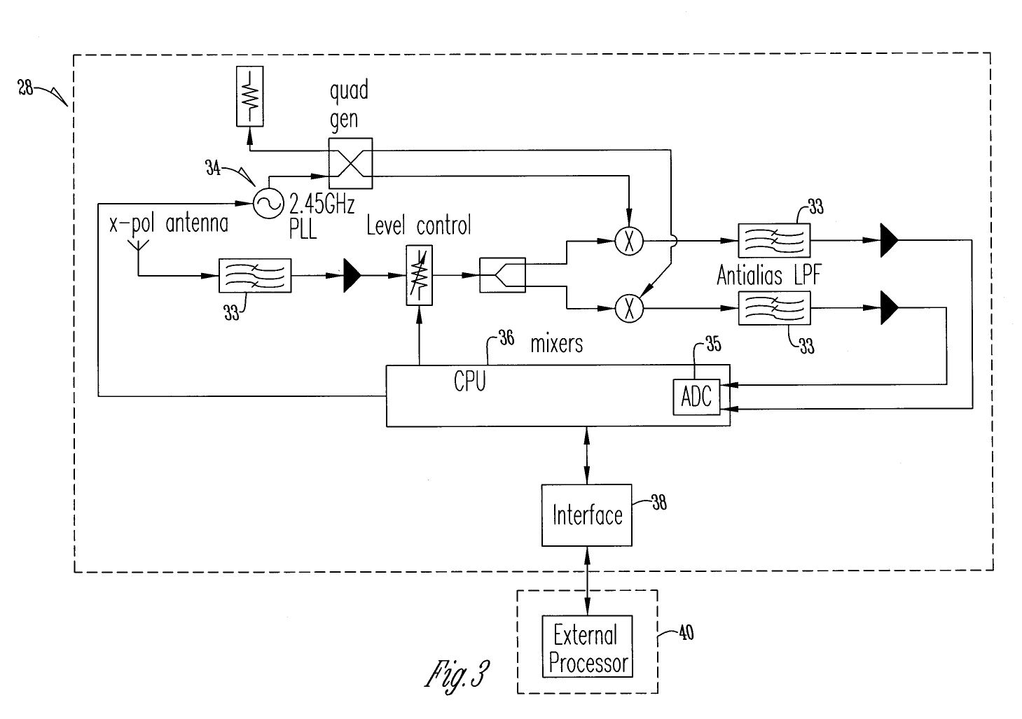

FIG. 4 is a schematic diagram of signal processing within a receiver system of a hard object assembly; and

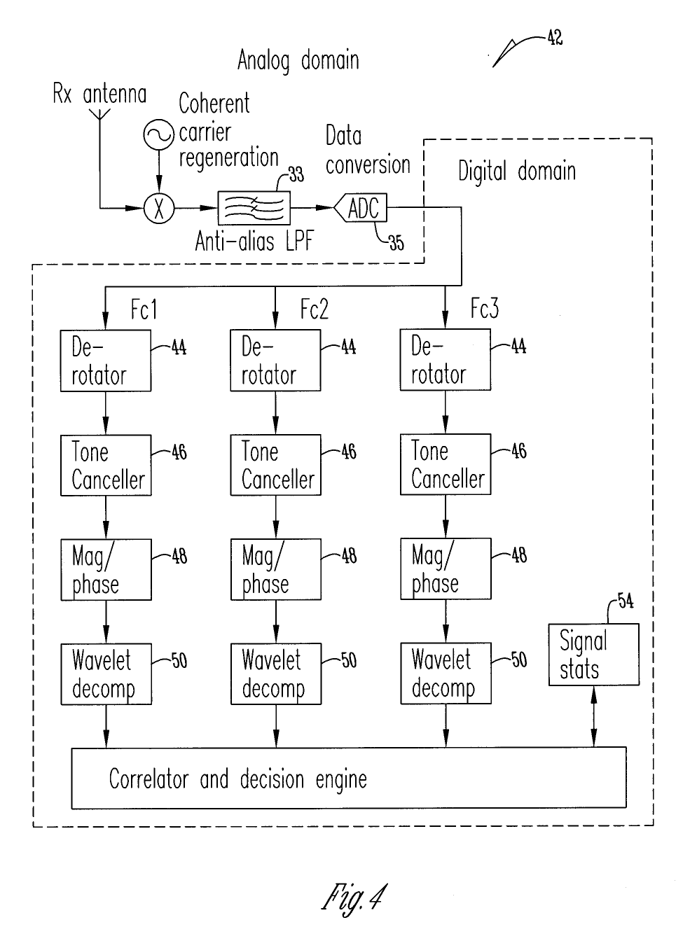

FIG. 5 is a block diagram of a hard object assembly.

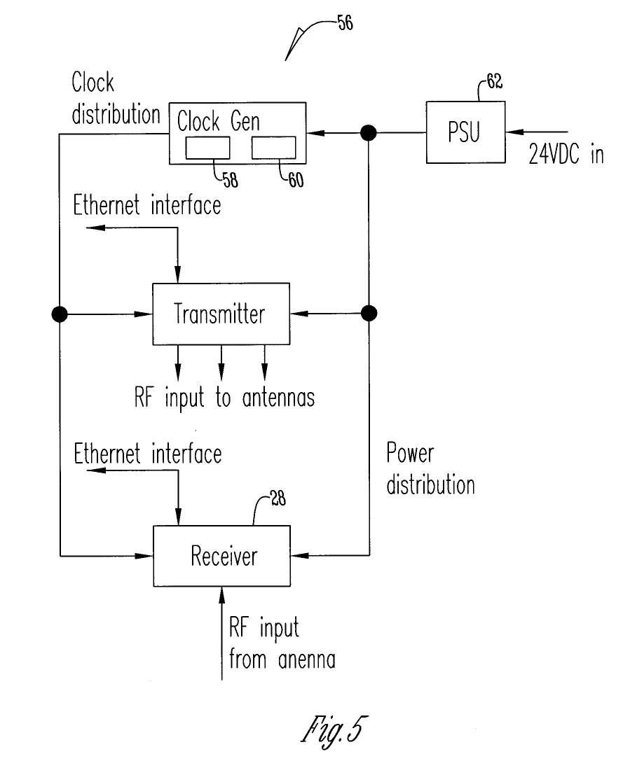

### DETAILED DESCRIPTION OF THE PREFERRED EMBODIMENT

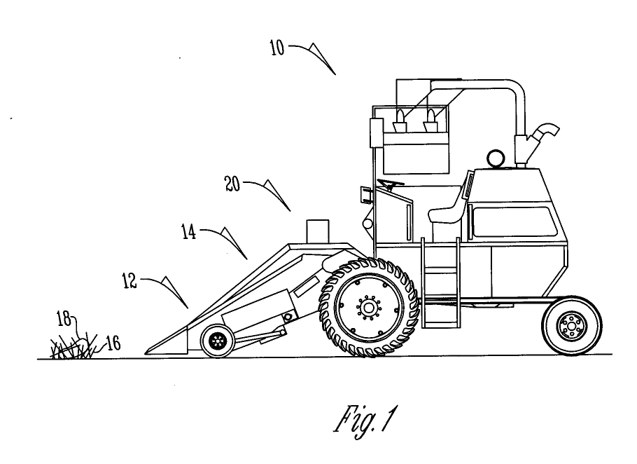

FIG. 1 shows an agricultural vehicle 10 having a frame 12 with an inlet 14 for intaking a crop mat 16 that can include a hard object 18 such as a rock. In a preferred embodiment the agricultural vehicle is a combine. Connected and attached to the frame 12 is a hard object assembly 20 for detecting hard objects 18 within the crop mat 16.

The hard object assembly 20 includes a plurality of antennae including a transmitting antenna 22 that is disposed between and adjacent to first and second broadcasting antennae 24 and 26. The broadcasting antennae have broadcasting carrier tones that are unique such as, but not limited to, 1 kHz above and 1 kHz below the transmitting antenna 22. These antennae transmit microwave signals simultaneously toward the crop mat 16 to detect a hard object 18. These signals are all received by a receiver system 28 which include one or more receiving antenna 30.

The receiver system 28 includes receiver antenna 30 that communicate the transmitted microwaves to a receiver card 32. In a preferred embodiment the receiver antenna 30 are fabricated within a high density polyethylene radome. The receiver system also includes a band pass filter 33 and receiver local oscillator 34 that is based on a fractional-N phase locked loop that is locked to the same frequency reference as the transmitters 22, 24 and 26. Because of this the oscillator 34 is phased coherent with respect to the transmitters 22, 24 and 26 and a direct measurement of phase can be carried out between the receiver system 28 and all transmitters. Receiver system in one embodiment includes analog to digital converters (ADCs) 35. Down converted signals are sampled and processed by a single chip digital signal processor (DSP) 36. The DSP 36 also can manage an interface 38 carrying out command exchanges and streaming data to an external computing device 40 for analysis.

The software 42 of the receiver system 28 controls the receiver hardware as well as performing the necessary data reduction detection of possible obstructions. These tests can be divided into real time and non real time procedures. Real time procedures include analog to digital converter sampling and event clock operations. All other signal processing steps can be done in a non real time fashion as long as the processing through put is sufficient to absorb the data streaming from the analog to digital converters 35 and perform the required data reduction with a minimum of latency such that object detection occurs within permissible times.

The software 42 may include a de-rotator 44 that is the last stage of down conversion. Specifically, frequency offset tones are digitally mixed down to a zero frequency complex signal before further processing is carried out. A low pass filter can also be applied after the conversion.

Additionally, included in the software 42 is a tone canceller 46 that is utilized when spurious tones or interference is present. Specifically, tones on the received signal 46 can spoil the detection sensitivity and for this reason it is desirable to eliminate any discrete tones that might appear within the detector bandwidth.

The software 42 can also include a magnitude/phase extraction 48, a wavelet decomposition 50, correlation/decision engine 52 and signals statistics generator 54. The magnitude phase extraction 48 cleans up the signal in order to generate an instantaneous magnitude and phase. It is here that we begin to see the clear effects of obstructions moving into and out of the sensor zone. Meanwhile the wavelet decomposition 50 is a wavelet filter bank that is utilized to rank disturbances by scale and time of occurrence. This additionally has the added benefit of compressing the volume of sensor data and simplifying the correlation operation that follows. Specifically, the wavelet decomposition 50 reduces noises on the incoming signals as well as sifts through the signals. The correlation decision engine (not shown) compares the receiver signals with one another as well as a set of possible signature data sets to maximize the probability of correctly identifying the presence of a hard object 18 within the crop mat 16. Finally, the signal statistics 54 provides a plurality of statistics including signal means, square magnitudes, time windowed block average phases, time windowed block phase deviations, block phased cross correlations, and magnitude cross correlations.

A clock system 56 is electrically connected to the transmitting antennae 22, 24 and 26 along with the receiver system 28 to provide proper timing to the system 20. The clock system 56 includes a temperature compensated crystal oscillator 58 and a distribution amplifier 60.

In a preferred embodiment a power supply unit 62 powers the assembly 20. In one embodiment the power supply unit 62 is a galvanically isolated, transformer coupled DC-DC converter with several onboard regulators.

In operation the transmitting antenna 22, first broadcasting antenna 24, and second broadcasting antenna 26 transmit microwave signals toward a crop mat 16. The microwave signals are transmitted and detect the crop mat 16 and hard objects 18 therein and are received by the receiver system 28.

Specifically, the signal passing through the crop mat 16 is received by the receiver antenna 30 and pass through a band pass filter 33 centered at 2.45 GHZ. The radio frequency (RF) signals amplified and mixed with the oscillator 34 whose frequency displacement generates a set of beat notes in the kHZ range. These tones are filtered and presented to analog to digital converters 35. All further processing takes place in the digital domain within the DSP 36. The DSP 36 also maintains contact with an external computing device (controller/decision engine) 40, internet or otherwise. After the 2.45 transmitter signals pass through the moving crop mat 16 the composite signal is received by the receiver antenna 30. The antenna signal is then filtered and amplified. In order to control the level the signal presented to the analog to digital converters 35, a digital variable attenuator, under control of the processor is used for an open loop level control.

As a result, the receiver system 28 determines the phase of the microwave signal measured between the transmitting and receiver antennae 22 and 30. The receiver system 28 similarly determines the magnitude of these microwaves. When an opaque obstruction such as a hard object 18, like a rock, is moved into the detection area of the hard object assembly 20, the receiver system 28 will recognize a rapid phase jump.

The receiver system 28 also determines shadowing and Doppler effects as a result of the hard object 18.

Specifically, the phase jump is a direct manifestation of Doppler that can be utilized to detect the presence of a moving obstruction or hard object 18 within a crop mat 16 where a shadowing effects are highlighted by signal magnitude. Specifically, a sudden decrease in the signal is detected when the hard object 18 is within the transmission field of the hard object assembly 20. This is manifested within the wavelet decomposition 50 that shows the scale of the detection of the event. Alternatively the phenomenon of scattering can be utilized.

In addition the receiver system 28 can determine phase shift peaks due to a moving hard object 18. Specifically, there is a notable shift in magnitude as a hard object 18 passes through a sensor field provided by the hard object assembly 20 indicating a significant change in beam shadowing. Thus, as a hard object 18 such as rock passes through the sensor field of the hard object assembly 20 there is not only some brief shadowing but additionally some enhancement of signal transmission from the transmitter antenna 22 to the receiver antenna 30. This is indicated by the amplitude peak that rises above base line amplitude. Finally, wavelet decomposition 50 of phase/magnitude of hard object motion is presented. Specifically, coefficient values are lower than for an opaque object; however, the noise effect of the wavelet decomposition makes the motion signature apparent.

Thus, by using these various methods the hard object assembly 20 determines that a hard object 18 is within the crop mat and can signal an operator so that the agricultural vehicle 20 can be stopped before the hard object 18 reaches the inlet 14 or an automated shutdown/ejection device can be activated and thereby protect the processing machine.

Therefore presented is an agricultural vehicle 10 that utilizes a hard object assembly 20 in order to detect hard objects 18 within a crop mat 16. By doing so, an operator can stop the vehicle 10 before taking in the hard object 18 thus creating damage within the interior of the vehicle 10. The system is not only efficient but additionally cost effective and easy to use. Thus, at the very least all of the stated objectives have been met.

It will be appreciated by those skilled in the art that other various modifications could be made to the device without departing from the spirit and scope of this invention.

All such modifications and changes fall within the scope of the claims and are intended to be covered thereby.

1. An agricultural vehicle comprising:
a frame having an inlet for intaking a crop mat;
a hard object assembly connected to the frame and including a receiver system;
wherein the hard object assembly includes a plurality of antennae that transmits microwaves that are received by the receiver system to detect a hard object in the crop mat; and
wherein the receiver system has a local oscillator and utilizes a fractional N phase locked loop phased coherent with the transmitting antennae such that a direct measurement of phase is carried out between the receiver system and the transmitting antennae.

2. The agricultural vehicle of claim 1 wherein the receiver system has a receiver card with receiver software that measures the magnitude of the phase of the microwaves received.

3. The agricultural vehicle of claim 1 wherein the hard object assembly comprises a transmitting antenna disposed between first and second broadcasting antenna and spaced apart from the receiver system.

4. (canceled)

5. The agricultural vehicle of claim 1 wherein the receiver system measures the Doppler effect of the microwaves.

6. The agricultural vehicle of claim 1 wherein the receiver system measures the shadowing of the microwaves.

7. The agricultural vehicle of claim 1 wherein the agricultural vehicle is a combine.

8. The agricultural vehicle of claim 1 wherein the hard object is a rock.
